(19) United States
(12) Patent Application Publication
(10) Pub. No.: US 2015/0350310 A1
(43) Pub. Date: Dec. 3, 2015

(54) Cloud Transport Platform (CTP) Based Data Transmission Method, System and Corresponding Cloud Transport Platform

(71) Applicant: Tencent Technology (Shenzhen) Company Limited, Shenzhen (CN)

(72) Inventors: Mingsheng Huang, Shenzhen (CN); Hongkai Qi, Shenzhen (CN); Zhimin He, Shenzhen (CN)

(73) Assignee: TENCENT TECHNOLOGY (SHENZHEN) COMPANY LIMITED, Shenzhen (CN)

(21) Appl. No.: 14/734,622

(22) Filed: Jun. 9, 2015

Related U.S. Application Data
(63) Continuation of application No. PCT/CN2013/090361, filed on Dec. 24, 2013.

(30) Foreign Application Priority Data
Jan. 9, 2013 (CN) 201310007595.9

(51) Int. Cl. H04L 29/08

(52) U.S. Cl. CPC H04L 67/10; H04L 67/18

(57) ABSTRACT

The present invention relates to a Cloud Transport Platform (CTP) based data transmission method, system and corresponding cloud transport platform. The method comprises: a first transmission node receiving data for transmission from a transmitting terminal; said first transmission node dividing said data into a plurality of sections in accordance with position information of said first transmission node, position information of a second transmission node, and transmission delay information between said first transmission node and said second transmission node, and sending said plurality of sections concurrently to said second transmission node; said second transmission node receiving and combining said plurality of sections; and said second transmission node sending said combined data to a receiving terminal. The present invention also relates to a CTP based data transmission system and corresponding cloud transport platform. In accordance with the CTP Based data transmission method, system and corresponding cloud transport platform provided by the present invention, data for transmission is divided into a plurality of sections in accordance with position and transmission delay information of the transmission nodes, which effectively enhances the speed of data transmission while conserving network resources.

### CROSS-REFERENCE TO RELATED APPLICATIONS

This application is a continuation of International Patent Application No. PCT/CN2013/090361, entitled “Cloud Transport Platform (CTP) Based Data Transmission Method, System and Corresponding Cloud Transport Platform,” filed on Dec. 24, 2013. This application claims the benefit and priority of Chinese Patent Application No. 201310007595.9, entitled “Cloud Transport Platform (CTP) Based Data Transmission Method, System and Corresponding Cloud Transport Platform,” filed on Jan. 9, 2013. The entire disclosures of each of the above applications are incorporated herein by reference.

### TECHNICAL FIELD

The present invention relates to data transmission, and more particularly to a Cloud Transport Platform (CTP) based data transmission method, system and corresponding cloud transport platform.

### BACKGROUND

With the development of the internet technology, the volume of data to be transmitted is becoming larger and larger. In order to improve the efficiency of data transmission, vendors have developed a variety of shared cloud transport platform (“CTP”), which has the capability to transmit large volume of data to a target address in high speed, while the user only needs to send the data to the CTP.

There are at least the following issues in the prior art. Nearly all the existing CTPs use the Transmission Control Protocol (“TCP”) to transmit data, and the network connection is generally limited by TCP's sliding windows and congestion control. Thus, it is hard to achieve high transmission speed when there is large volume of data, poor network quality, or long transmission route.

Therefore, there is a need to provide an efficient CTP based data transmission method, system and corresponding cloud transport platform to address the issues in the prior art.

### SUMMARY OF THE INVENTION

The purpose of the present invention is to provide a CTP Based data transmission method, system and corresponding cloud transport platform, wherein data for transmission is divided into a plurality of sections in accordance with position and transmission delay information of the transmission nodes, which effectively enhances the speed of data transmission while conserving network resources. The present invention addresses the issue of transmission speed being significantly affected by the transmission network in existing CTP Based data transmission methods and systems.

In accordance with embodiments of the present invention, a CTP based data transmission method is provided, the method comprising: a first transmission node receiving data for transmission from a transmitting terminal; said first transmission node dividing said data into a plurality of sections in accordance with position information of said first transmission node, position information of a second transmission node, and transmission delay information between said first transmission node and said second transmission node, and sending said plurality of sections concurrently to said second transmission node; said second transmission node receiving and combining said plurality of sections; and said second transmission node sending said combined data to a receiving terminal.

In accordance with embodiments of the present invention, a CTP based data transmission system is also provided, the system comprising: a receiving module for receiving data for transmission from a transmitting terminal; a division module for dividing said data into a plurality of sections in accordance with position information of a first transmission node, position information of a second transmission node, and transmission delay information between said first transmission node and said second transmission node, and sending said plurality of sections concurrently to said second transmission node; a combination module for receiving and combining said plurality of sections; and a transmission module for sending said combined data to a receiving terminal.

In accordance with embodiments of the present invention, a cloud transport platform is provided, comprising a first transmission node receiving data for transmission from a transmitting terminal, and a second transmission node sending said data to a receiving terminal, wherein said first transmission node comprises: a receiving module receiving said data from said transmitting terminal; a division module for dividing said data into a plurality of sections in accordance with position information of said first transmission node, position information of said second transmission node, and transmission delay information between said first transmission node and said second transmission node, and sending said plurality of sections concurrently to said second transmission node; and wherein said second transmission node comprises: a combination module for receiving and combining said plurality of sections; and a transmission module for sending said combined data to said receiving terminal.

The present invention provides a CTP Based data transmission method, system and corresponding cloud transport platform, wherein data for transmission is divided into a plurality of sections in accordance with position and transmission delay information of the transmission nodes, which effectively enhances the speed of data transmission while conserving network resources. The embodiments of the present invention address the issue of transmission speed being significantly affected by the transmission network in existing CTP Based data transmission methods and systems.

### BRIEF DESCRIPTION OF THE DRAWINGS

FIG. 1 is an exemplary flowchart for a CTP based data transmission method in accordance with a first preferable embodiment of the present invention.

FIG. 2 is an exemplary flowchart for a CTP based data transmission method in accordance with a second preferable embodiment of the present invention.

FIG. 3 is an exemplary flowchart for a CTP based data transmission method in accordance with a third preferable embodiment of the present invention.

FIG. 4 is an exemplary structural diagram for a CTP based data transmission system in accordance with the first preferable embodiment of the present invention.

FIG. 5 is an exemplary structural diagram for a CTP based data transmission system in accordance with the second preferable embodiment of the present invention.

FIG. 6 is an exemplary structural diagram for a CTP based data transmission system in accordance with the third preferable embodiment of the present invention.

FIG. 7 is an exemplary diagram of the operating principle of a CTP based data transmission method and system in accordance with the embodiments of the present invention.

### DESCRIPTION OF THE PREFERRED EMBODIMENTS

To better illustrate the purpose, technical feature, and advantages of the embodiments of the present invention, various embodiments of the present invention will be further described in conjunction with the accompanying drawings.

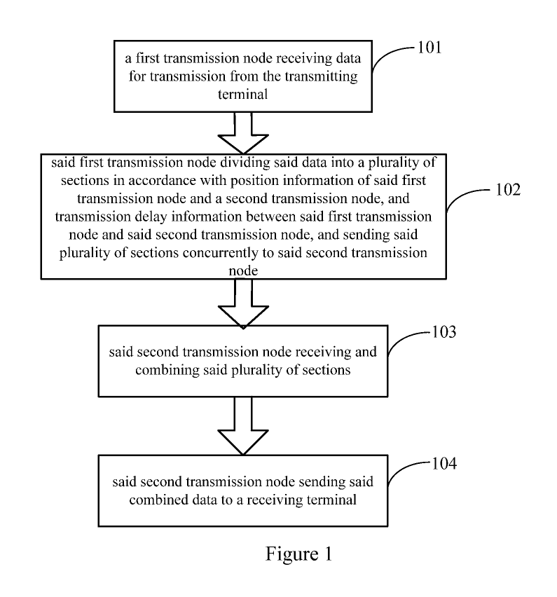

FIG. 1 is an exemplary flowchart for a CTP based data transmission method in accordance with a first preferable embodiment of the present invention. As shown in FIG. 1, the cloud transport platform includes a first transmission node for receiving data for transmission from a transmitting terminal and a second transmission node for sending said data to a receiving terminal. The CTP based data transmission method in accordance with the preferred embodiment of the present invention includes the following steps:

Step 101, a first transmission node receiving data for transmission from the transmitting terminal;

Step 102, said first transmission node dividing said data into a plurality of sections in accordance with position information of said first transmission node, position information of a second transmission node, and transmission delay information between said first transmission node and said second transmission node, and sending said plurality of sections concurrently to said second transmission node;

Step 103, said second transmission node receiving and combining said plurality of sections; and

Step 104, said second transmission node sending said combined data to a receiving terminal.

The CTP based data transmission method in accordance with the preferred embodiment of the present invention concludes at Step 104.

The specific processes in each step of the CTP based data transmission method in accordance with the preferred embodiment of the present invention will be illustrated in details below.

In step 101, a persistent connection between the transmitting terminal and the first transmission node (a transmission node within the CTP that is close to the transmitting terminal) of the CTP is established, and the data is sent to said first transmission node in accordance with an previously-agreed application layer protocol. In this step, the transmitting terminal does not need to concern about the size of the data, and can send the data to the CTP directly. Since the first transmission node and the transmitting terminal are normally in the same region, the data transmission speed can generally achieve the maximum speed of the network connection, which would not slow down the overall data transmission.

Then step 102 follows.

In step 102, in accordance with the position information of the first transmission node, the position information of the second transmission node, and the transmission delay information between the first transmission node and the second transmission node, the CTP will first determine the capacity of the data transmission, i.e., the amount of data that each transmission line can transmit while meeting the system delay requirement. Subsequently, the first transmission node will divide the data into a plurality of sections in accordance with the capacity of the data transmission, and send the plurality of sections concurrently to the second transmission node. Thus, the transmission delay for the entire transmission process will be within the system requirement, which ensures a high transmission speed.

Then step 103 follows.

In step 103, the second transmission node receives and combines the data from the first transmission node. The connection between the first transmission node and the second transmission node is also a persistent connection, which further enhances the transmission speed.

Then step 104 follows.

In step 104, the second transmission node sends the combined data to the receiving terminal. A persistent connection between the receiving terminal and the second transmission node (a transmission node within the CTP that is close to the receiving terminal) of the CTP is also established, and said second transmission node sends the data to the receiving terminal in accordance with a previously-agreed application layer protocol. Since the second transmission node and the receiving terminal are usually in the same region, the data transmission speed can generally achieve the maximum speed of the network connection, which would not significantly slow down the overall data transmission.

The CTP based data transmission method in accordance with this preferred embodiment concludes after the receiving terminal receives all the data.

The CTP Based data transmission method of the preferred embodiment divides the data for transmission into a plurality of sections in accordance with position and transmission delay information of the transmission nodes, which effectively enhances the speed of data transmission while conserving network resources.

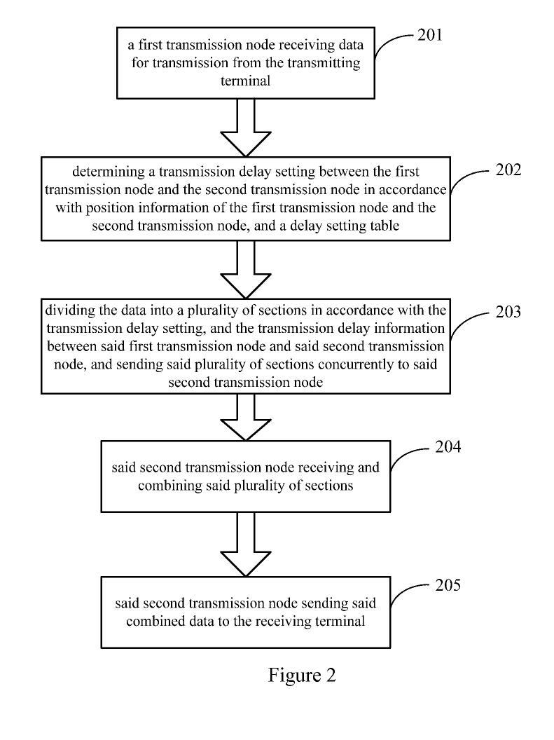

FIG. 2 is an exemplary flowchart for a CTP based data transmission method in accordance with a second preferable embodiment of the present invention. As shown in FIG. 2, the cloud transport platform includes a first transmission node for receiving data for transmission from a transmitting terminal and a second transmission node for sending said data to a receiving terminal. The CTP based data transmission method in accordance with this preferred embodiment of the present invention includes the following steps:

Step 201, a first transmission node receiving data for transmission from the transmitting terminal;

Step 202, determining a transmission delay setting between the first transmission node and the second transmission node in accordance with position information of the first transmission node, position information of the second transmission node, and a delay setting table;

Step 203, dividing the data into a plurality of sections in accordance with the transmission delay setting, and the transmission delay information between said first transmission node and said second transmission node, and sending said plurality of sections concurrently to said second transmission node;

Step 204, said second transmission node receiving and combining said plurality of sections; and

Step 205, said second transmission node sending said combined data to the receiving terminal;

The CTP based data transmission method in accordance with this preferred embodiment of the present invention concludes at Step 205.

The specific processes in each step of the CTP based data transmission method in accordance with the preferred embodiment of the present invention will be illustrated in details below.

Step 201 in this preferred embodiment is identical with or similar to Step 101 in the preferred embodiment above, and the description of step 101 can be referenced for the details of Step 201.

Then step 202 follows.

In step 202, a transmission delay setting is located in a delay setting table, and the transmission delay setting is the maximum delay allowable between the first transmission node and the second transmission node, i.e., if the transmission delay between the first transmission node and the second transmission node is larger than the transmission delay setting, then it would be determined that data need to be divided into smaller sections to decrease the transmission delay.

Then step 202 follows.

In step 203, after obtaining the transmission delay setting in step 202, data is divided into a plurality of sections in accordance with a preset parameter (e.g., 4 k to 10 k), and transmission delay information in transmitting the plurality of sections between the first transmission node and the second transmission node is obtained. If the transmission delay in the transmission delay information for the plurality of sections is larger than the transmission delay setting, the data will be further divided into smaller sections until the transmission delay is equal to or less than the transmission delay setting, and all the divided data will be sent concurrently to the second transmission node.

Then step 204 follows.

Step 204 in this preferred embodiment is identical with or similar to Step 103 in the preferred embodiment above, and the description of step 103 can be referenced for the details of Step 204.

Step 205 in this preferred embodiment is identical with or similar to Step 104 in the preferred embodiment above, and the description of step 104 can be referenced for the details of Step 205.

The CTP based data transmission method in accordance with this preferred embodiment concludes after the receiving terminal receives all the data.

The CTP Based data transmission method of this preferred embodiment determines the size of sections that the data will be divided into in accordance with a comparison between a transmission delay setting and the delay in the transmission delay information to ensure that present transmission delay setting is equal to or less than the delay, which enhances the data transmission speed efficiently.

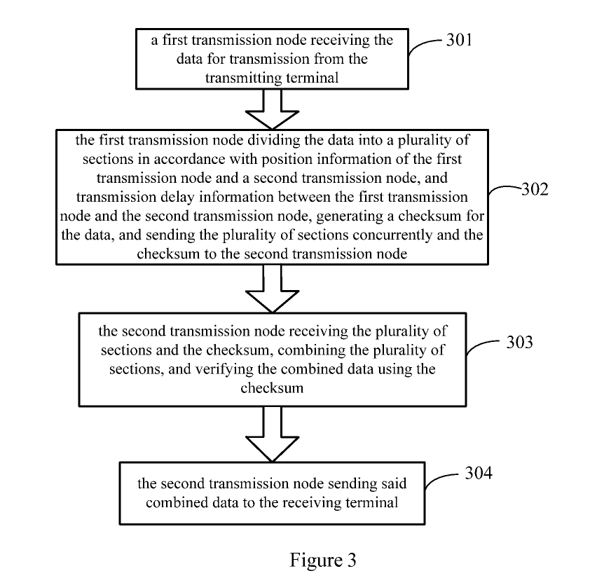

FIG. 3 is an exemplary flowchart for a CTP based data transmission method in accordance with a third preferable embodiment of the present invention. As shown in FIG. 3, the cloud transport platform includes a first transmission node for receiving data for transmission from a transmitting terminal and a second transmission node for sending said data to a receiving terminal. The CTP based data transmission method in accordance with this preferred embodiment of the present invention includes the following steps:

Step 301, a first transmission node receiving the data for transmission from the transmitting terminal;

Step 302, the first transmission node dividing the data into a plurality of sections in accordance with position information of the first transmission node, position information of a second transmission node, and transmission delay information between the first transmission node and the second transmission node, generating a checksum for the data, and sending the plurality of sections concurrently and the checksum to the second transmission node;

Step 303, the second transmission node receiving the plurality of sections and the checksum, combining the plurality of sections, and verifying the combined data using the checksum;

Step 304, the second transmission node sending said combined data to the receiving terminal;

The CTP based data transmission method in accordance with this preferred embodiment of the present invention concludes at Step 304.

The specific processes in each step of the CTP based data transmission method in accordance with the preferred embodiment of the present invention will be illustrated in details below.

Step 301 in this preferred embodiment is identical with or similar to Step 101 in the preferred embodiment above, and the description of step 101 can be referenced for the details of Step 301.

Step 302 in this preferred embodiment is identical with or similar to Step 102 in the preferred embodiment above, and the description of step 102 can be referenced for the details of Step 302.

Then step 303 follows.

The difference between Step 303 and Step 103 is that, in Step 303, when the second transmission node receives the plurality of sections, it also receives a checksum for the data; and when the second transmission node combines the plurality of sections, it verifies the combined data with the checksum.

Then step 304 follows.

Step 304 in this preferred embodiment is identical with or similar to Step 104 in the preferred embodiment above, and the description of step 104 can be referenced for the details of Step 304.

The CTP based data transmission method in accordance with this preferred embodiment of the present invention concludes when the receiving terminal receives all the data.

The CTP based data transmission method in accordance with this preferred embodiment of the present invention conducts verification with a checksum, such as MD5, on the basis of the first preferable embodiment, which ensures not only high data transmission speed but also the integrity of the transmission data.

According to one preferred embodiment of this CTP based data transmission method, each section comprises a sequence and a section identifier.

According to another preferred embodiment of this CTP based data transmission method, a section comprises a checksum for the data.

According to another preferred embodiment of this CTP based data transmission method, dividing the data into a plurality of sections is implemented in an application layer.

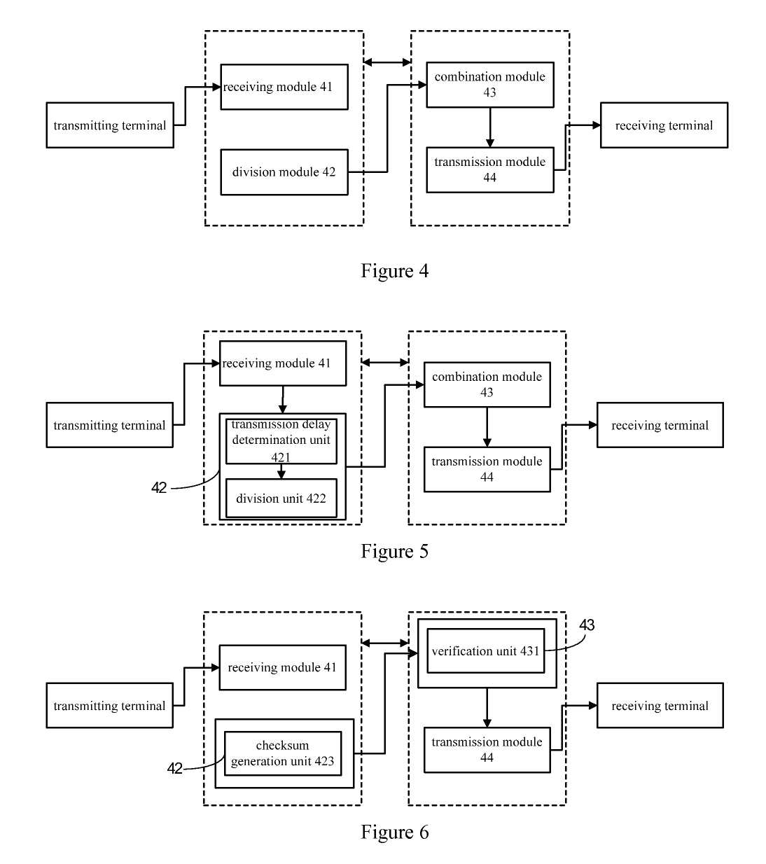

The present invention also provides a CTP based data transmission system. FIG. 4 is an exemplary structural diagram for a CTP based data transmission system in accordance with a first preferable embodiment of the present invention. The CTP Based data transmission system comprises a first transmission node for receiving data for transmission from a transmitting terminal and a second transmission node for sending said data to a receiving terminal. The CTP based data transmission system comprises a receiving module 41, a division module 42, a combination module 43 and a transmission module 44. The receiving module 41 receives data for transmission from the transmitting terminal; the division module 42 divides the data into a plurality of sections in accordance with position information of the first transmission node, position information of the second transmission node, and transmission delay information between the first transmission node and the second transmission node, and sends the plurality of sections concurrently to the second transmission node; the combination module 43 receives and combines the plurality of sections; and the transmission module 44 sends the combined data to the receiving terminal.

In the CTP based data transmission system in accordance with the preferred embodiment of the present invention, the connection between the first transmission node and the transmitting terminal is a persistent connection, the connection between the second transmission node and the receiving terminal is a persistent connection, and the connection between the first transmission node and the second transmission node is a persistent connection.

During the operation of the CTP based data transmission system in accordance with the preferred embodiment of the present invention, firstly, the receiving module 41 receives data for transmission from the transmitting terminal; secondly, the division module 42 divides the data into a plurality of sections in accordance with position information of the first transmission node, position information of the second transmission node, and transmission delay information between the first transmission node and the second transmission node, and sends the plurality of sections concurrently to the second transmission node; third, the combination module 43 receives and combines the plurality of sections; and lastly, the transmission module 44 sends the combined data to the receiving terminal.

The operational principle of this preferred embodiment of the CTP based data transmission system is identical with or similar to the description of the first preferred embodiment of the CTP based transmission method mentioned above, the description of the CTP based data transmission method can be referenced for the details of this CTP based data transmission system.

The CTP Based data transmission system of the preferred embodiment divides the data for transmission into a plurality of sections in accordance with position and transmission delay information of the transmission nodes, which effectively enhances the speed of data transmission while conserving network resources.

FIG. 5 is an exemplary structural diagram for the CTP based data transmission system in accordance with a second preferable embodiment of the present invention. The difference between this second preferable embodiment and the first preferable embodiment is that, in this second preferable embodiment, the division module 42 includes a transmission delay determination unit 421 and a division unit 422. The transmission delay determination unit 421 determines a transmission delay setting between the first transmission node and the second transmission node in accordance with position information of the first transmission node, position information of the second transmission node, and a delay setting table; the division unit 422 divides said data into a plurality of sections in accordance with the transmission delay setting, and transmission delay information between the first transmission node and the second transmission node, and sends the plurality of sections concurrently to the second transmission node. Specifically, the data is divided into a plurality of sections in accordance with a preset parameter; if the delay in the transmission delay information for the plurality of sections is larger than the transmission delay setting, the data is further divided into smaller sections until the delay is equal to or less than the transmission delay setting, and all the divided sections are sent concurrently to the second transmission node.

During the operation of the CTP based data transmission system in accordance with the preferred embodiment of the present invention, firstly, the receiving module 41 receives data for transmission from the transmitting terminal; secondly, the transmission delay determination unit 421 of the determining module 42 determines a transmission delay setting between the first transmission node and the second transmission node in accordance with position information of the first transmission node, position information of the second transmission node, and a delay setting table; thirdly, the division unit 422 of the division module 42 divides the data into a plurality of sections in accordance with the transmission delay setting and the transmission delay information between the first transmission node and the second transmission node, and sends the plurality of sections concurrently to the second transmission node; fourthly, the combination module 43 receives and combines the plurality of sections; and lastly, the transmission module 44 sends the combined data to the receiving terminal.

The operational principle of this preferred embodiment of the CTP based data transmission system is identical with or similar to the description of the second preferred embodiment of the CTP based transmission method discussed above, the description of the CTP based data transmission method can be referenced for the details of the CTP based data transmission system.

The CTP Based data transmission system of this preferred embodiment determines the size of sections that the data will be divided into in accordance with a comparison between a transmission delay setting and the delay in the transmission delay information to ensure that present transmission delay setting is equal to or less than the delay, which enhances the data transmission speed efficiently.

FIG. 6 is an exemplary structural diagram for the CTP based data transmission system in accordance with the third preferable embodiment of the present invention. The difference between this third preferred embodiment and the first preferred embodiment is that, in this third preferred embodiment, the division module 42 also includes a checksum generation unit 423, and the combination module 43 also includes a verification unit 431. The checksum generation unit 423 generates and sends a checksum of the data to the second transmission node. The verification unit 431 receives the checksum and use the checksum to verify the integrity of the combined data.

In the CTP based data transmission system in accordance with this preferred embodiment of the present invention, firstly, the receiving module 41 receives the data for transmission from the transmitting terminal; secondly, the division module 42 divides the data into a plurality of sections in accordance with position information of the first transmission node, position information of the second transmission node, and transmission delay information between the first transmission node and the second transmission node, with the checksum generation unit 423 meanwhile generating the checksum for the entire data, and sends the plurality of sections concurrently and the checksum to the second transmission node; thirdly, the combination module 43 receives and combines the plurality of sections, while the verification unit 431 verifies the integrity of the combined data using the checksum; and lastly, the transmission module 44 sends the combined data to the receiving terminal.

The operational principle of this preferred embodiment of the CTP based data transmission system is identical with or similar to the description of the third preferred embodiment of the CTP based transmission method mentioned above, the description of this CTP based data transmission method can be referenced for the details of the CTP based data transmission method.

The CTP based data transmission system in accordance with this preferred embodiment of the present invention conducts verification with checksum such as MD5 on the basis of the first preferable embodiment, which not only ensures high data transmission speed but also the integrity of the transmission data.

According to one preferred embodiment of this CTP based data transmission method, each section comprises a sequence and a section identifier.

According to another preferred embodiment of this CTP based data transmission method, a section comprises a checksum for the data.

According to another preferred embodiment of this CTP based data transmission method, dividing the data into a plurality of sections is implemented in an application layer.

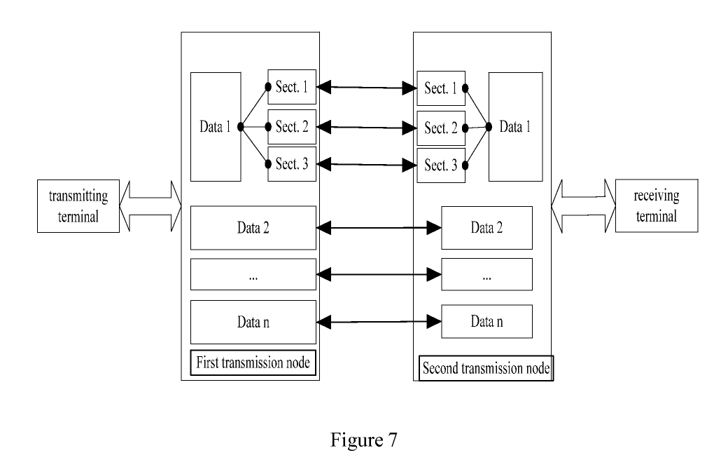

FIG. 7 is an exemplary diagram of working principle for the CTP based data transmission method and system in accordance with the embodiments of the present invention. The operational principles of the CTP based data transmission method and system in accordance with the embodiments of the present invention will be illustrated in details below.

Suppose that the transmitting terminal is in Shenzhen, and the receiving terminal is in Tianjin. Then, the first transmission node should also be in Shenzhen, i.e., being in the same region as the transmitting terminal, and the second transmission node should be in Tianjin, i.e., being in the same region as the receiving terminal. The connection between the transmitting terminal and the CTP is a persistent connection, and the transmitting terminal sends a plurality of data to the first transmission node of the CTP. The preset parameter is 10 k. The transmission delay setting between the two cities is determined to be 30 ms according to a delay setting table. If the size of data 1 is 30 k, then data 1 will be divided into three sections in accordance to the preset parameter. If the size of other data is less than 10 k, then such data will not be divided. The connection between the first transmission node and the second transmission node is a persistent connection, and the delay in the transmission delay information between the first transmission node and the second transmission node for transmitting the divided data is determined to be 28 s, which is less than <30 s, and the plurality of sections is sent concurrently to the second transmission node. As described here, the plurality of sections are sent “concurrently” means sending each section through a separate network connection, such as a TCP connection. In order to avoid the possibility that some network connections might be needed to transmit other data, the number of the connections can be more than the number of the sections to ensure high transmission speed for all the sections. In the meantime, the checksum for the data is also sent to the second transmission node.

When the second transmission node receives the divided data, it combines the sections as data 1 (the checksum can also be used to verify the integrity of the combined data), and subsequently, all the data will be sent to the receiving terminal directly through a persistent connection.

The preferred embodiments of the present invention provides a cloud transport platform comprising a first transmission node for receiving data for transmission from a transmitting terminal and a second transmission node for sending said data to a receiving terminal. The first transmission node includes the receiving module and the division module of the CTP based data transmission system discussed above; the second transmission node includes the combination module and transmission module of the CTP based data transmission system discussed above.

The operational principle of the preferred embodiment of the cloud transport platform is identical with or similar to the description of the preferred embodiments of the CTP based transmission method and system mentioned above, the description of the CTP based data transmission method and system can be referenced for the details of the cloud transport platform.

In accordance with the Cloud Transport Platform (CTP) Based data transmission method, system and corresponding cloud transport platform provided by the present invention, data for transmission is divided into a plurality of sections in accordance with position and transmission delay information of the transmission nodes, which effectively enhances the speed of data transmission while conserving network resources. The embodiments of the present invention can be directly applied to the existing transmitting and receiving terminals without the need for reconfiguration. The embodiments of the present invention address the issue of transmission speed being significantly affected by the transmission network in existing CTP Based data transmission methods and systems.

The various embodiments of the present invention are merely preferred embodiments, and are not intended to limit the scope of the present invention, which includes any modification, equivalent, or improvement that does not depart from the spirit and principles of the present invention.

1. A Cloud Transport Platform (CTP) Based data transmission method, comprising:
a first transmission node receiving data for transmission from a transmitting terminal;
said first transmission node dividing said data into a plurality of sections in accordance with position information of said first transmission node, position information of a second transmission node, and transmission delay information between said first transmission node and said second transmission node, and sending said plurality of sections concurrently to said second transmission node;
said second transmission node receiving and combining said plurality of sections; and
said second transmission node sending said combined data to a receiving terminal.

2. The method of claim 1, wherein the step of said first transmission node dividing said data into a plurality of sections in accordance with position information of said first transmission node, position information of a second transmission node, and transmission delay information between said first transmission node and said second transmission node, and sending said plurality of sections concurrently to said second transmission node further comprises:
determining a transmission delay setting between said first transmission node and said second transmission node in accordance with position information of said first transmission node, position information of said second transmission node, and a delay setting table; and
dividing said data into a plurality of sections in accordance with said transmission delay setting, and transmission delay information between said first transmission node and said second transmission node, and sending said plurality of sections concurrently to said second transmission node.

3. The method of claim 2, wherein the step of dividing said data into a plurality of sections in accordance with said transmission delay setting, and transmission delay information between said first transmission node and said second transmission node, and sending said plurality of sections concurrently to said second transmission node further comprises:
dividing said data into a plurality of sections in accordance with a preset parameter;
continuing to divide said data until the transmission delay in said transmission delay information is equal to or less than said transmission delay setting, and sending said plurality of sections concurrently to said second transmission node further comprises.

4. The method of claim 1, wherein the step of said first transmission node dividing said data into a plurality of sections in accordance with position information of said first transmission node, position information of a second transmission node, and transmission delay information between said first transmission node and said second transmission node, and sending said plurality of sections concurrently to said second transmission node further comprises:
said first transmission node dividing said data into a plurality of sections in accordance with position information of said first transmission node, position information of a second transmission node, and transmission delay information between said first transmission node and said second transmission node, generating a checksum for said data, and sending said plurality of sections concurrently and said checksum to said second transmission node.

5. The method of claim 4, wherein the step of said second transmission node receiving and combining said plurality of sections further comprises:
said second transmission node receiving said plurality of sections and said checksum, combining said plurality of sections, and verifying the combined data using the checksum.

6. The method of claim 1, wherein the connection between said first transmission node and said transmitting terminal is a persistent connection, the connection between said second transmission node and said receiving terminal is a persistent connection, and the connection between said first transmission node and said second transmission node is a persistent connection.

7. The method of claim 1, wherein each section comprises a sequence and a section identifier.

8. The method of claim 1, wherein sending said plurality of sections concurrently to said second transmission node comprising sending each section through a separate network connection.

9. The method of claim 1, wherein dividing said data into a plurality of sections is implemented in an application layer.

10. A Cloud Transport Platform (CTP) Based data transmission system, comprising:
a receiving module for receiving data for transmission from a transmitting terminal;
a division module for dividing said data into a plurality of sections in accordance with position information of a first transmission node, position information of a second transmission node, and transmission delay information between said first transmission node and said second transmission node, and sending said plurality of sections concurrently to said second transmission node;
a combination module for receiving and combining said plurality of sections; and
a transmission module for sending said combined data to a receiving terminal.

11. The system of claim 10, wherein said division module comprises:
a transmission delay determination unit for determining a transmission delay setting between said first transmission node and said second transmission node in accordance with position information of said first transmission node, position information of said second transmission node, and a delay setting table; and
a division unit for dividing said data into a plurality of sections in accordance with said transmission delay setting, and transmission delay information between said first transmission node and said second transmission node, and sending said plurality of sections concurrently to said second transmission node.

12. The system of claim 10, wherein said division unit is configured for:
dividing said data into a plurality of sections in accordance with a preset parameter;
continuing to divide said data until the transmission delay in said transmission delay information is equal to or less than said transmission delay setting, and send said plurality of sections concurrently to said second transmission node.

13. The system of claim 10, wherein said division module further comprises a checksum generation unit for generating a checksum for said data, and sending said checksum to said second transmission node.

14. The system of claim 13, wherein said combination module further comprises a verification unit for receiving said checksum, and verifying the combined data using the checksum.

15. The system of claim 10, wherein the connection between said first transmission node and said transmitting terminal is a persistent connection, the connection between said second transmission node and said receiving terminal is a persistent connection, and the connection between said first transmission node and said second transmission node is a persistent connection.

16. The system of claim 10, wherein each section comprises a sequence and a section identifier.

17. The system of claim 10, wherein sending said plurality of sections concurrently to said second transmission node comprising sending each section through a separate network connection.

18. The system of claim 10, wherein dividing said data into a plurality of sections is implemented in an application layer.

19. A cloud transmission platform, comprising a first transmission node for receiving data for transmission from a transmitting terminal, and a second transmission node for sending said data to a receiving terminal, wherein said first transmission node comprises:
a receiving module receiving said data from said transmitting terminal; and
a division module for dividing said data into a plurality of sections in accordance with position information of said first transmission node, position information of said second transmission node, and transmission delay information between said first transmission node and said second transmission node, and sending said plurality of sections concurrently to said second transmission node; and
wherein said second transmission node comprises:
a combination module for receiving and combining said plurality of sections; and
a transmission module for sending said combined data to said receiving terminal.
